(19) United States
(12) Patent Application Publication
(10) Pub. No.: US 2008/0054180 A1
(43) Pub. Date: Mar. 6, 2008

(54) APPARATUS AND METHOD OF DETECTING SECONDARY ELECTRONS

(76) Inventors: Charles Silver, Richmond, CA (US); Lawrence Muray, Moraga, CA (US); James Spallas, Alamo, CA (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/751,619

(22) Filed: May 21, 2007

Related U.S. Application Data
(60) Provisional application No. 60/803,131, filed on May 25, 2006.

(51) Int. Cl. G21K 5/04

(52) U.S. Cl. 250/307; 250/310

(57) ABSTRACT

A charged particle beam column package includes an assembly (e.g., comprising a plurality of layers, which can have a component coupled to one of the layers), and a solid state detector coupled to the assembly. Further, at least one of the layers has interconnects thereon.

### PRIORITY REFERENCE TO PRIOR APPLICATIONS

This application claims benefit of and incorporates by reference U.S. patent application Ser. No. 60/803,131, entitled “Method for Detecting Secondary Electrons in Miniature Electron Beam Columns Using Solid State Electron Detectors,” filed on May 25, 2006, by inventors Charles Silver et al.

### TECHNICAL FIELD

This invention relates generally to scanning electron microscopes (SEMs), and more particularly, but not exclusively, provides an apparatus and method for detecting backscattered and secondary electrons in an SEM (e.g., in miniature, table top, portable SEMs, etc.).

### BACKGROUND

Charged particle detectors, and, in particular, electron detectors are critical for high-contrast image formation from secondary electrons in SEMs. Conventional detectors used to detect secondary electrons have large dimensions and are susceptible to performance degradation caused by contamination. These problems can be more severe when conventional electron beam columns are scaled down in size to form miniature electron beam columns. Miniature electron beam columns have small, closely spaced lenses and other components, and require short working distances for high resolution increasing the chance of the detector surface being contaminated. These characteristics make it difficult to use conventional secondary electron detectors with miniature electron beam columns and achieve the required high collection efficiencies for good signal-to-noise ratios.

An Everhart-Thornley detector (ETD) is a device commonly used for collecting secondary and backscattered electrons in SEMs. The ETD consists of a biased collector grid surrounding a scintillator material which is coupled to a photomultiplier as a first stage of amplification. ETDs are often mounted in SEMs as “in-lens” detectors, situated within the column above the pole piece. This type of detector configuration can be used to detect electrons which are ejected from the sample and drift back up the column. The ETD is also commonly positioned beneath the pole piece in proximity to the sample to detect secondary electrons.

The size of the ETD makes it impractical for mounting in the lens of a miniature electron beam column because the lenses are typically separated by 0.1-10 mm, which is small compared to the dimensions of the ETD detector. Mounting the ETD below the pole piece would require moving the samples further away from the final lens causing degraded resolution. ETDs are further limited by their small solid angle for collecting incident electrons, resulting in relatively poor collection efficiency. Reduced collection efficiency results in inferior signal-to-noise ratios for a given beam current.

Microchannel plate (MCP) detectors are also commonly used for detecting secondary and backscattered electrons in SEMs. MCPs are constructed of a grid of channels, typically 1-100 um in diameter, and often oriented at a slight angle to the incident beam. When a bias voltage is applied between the top and bottom of the channel plate, incident electrons are accelerated and multiplied, resulting in current gain. However, MCPs are susceptible to rapid contamination due to the small bore of the channels, typically 4 um to 12 um in diameter. Contamination problems are aggravated when imaging samples containing photoresist or other such materials common to integrated circuit fabrication. In such cases, material can be ejected from the sample by electron bombardment from the primary beam. There is a long mean free path for such material in vacuum, and because the detector is typically mounted line-of-sight to the sample, contaminants from the sample can be deposited onto the detector. Such contamination in the channels can deteriorate the detector's signal-to-noise, and MCPs cannot be easily cleaned to recover their original signal-to-noise.

The thickness of the MCP is typically 0.5 mm or greater to achieve sufficient gain. In fact, for high-contrast imaging, MCPs are often stacked together in a dual chevron configuration in order to increase the overall detector gain. A dual stack of 1 mm total thickness means that the working distance (i.e., the distance between the final lens and the sample) must be greater than 1 mm, preventing miniature SEMs, in particular, from achieving their ultimate resolution. Furthermore, MCPs are often configured with a center aperture to allow the primary beam to pass through to the sample. MCP manufacturing processes typically require a dead area surrounding the center aperture, generally extending ˜1 mm outside the aperture. The dead area is in the region near the primary beam axis where most of the secondary electrons emitted from the sample are concentrated, and it therefore has the effect of reducing collection efficiency when placed very close to the sample.

A third detector commonly used is the continuous dynode electron multiplier. This type of detector consists of a single channel or multiple channels extruded through the length of a section of glass. Embedded within the glass is a layer of resistive lead glass which is used to generate increasing potential along the length of the channel between the anode and cathode when a bias voltage is applied between them. A charged particle incident on the front of the detector generates secondary electrons at the surface. As the secondary electrons travel through the channel they are accelerated by the increasing potential, causing them to hit the channel wall and generate more secondary electrons. This method of electron multiplication can result in up to 10⁸ electrons at the anode from a single charged particle incident on the surface. Continuous dynode electron multipliers can be used with SEMs to detect secondary electrons with extremely high gain. The incident surface, the entrance cone, and the channel can be manufactured in a wide variety of configurations to maximize collection efficiency and signal-to-noise characteristics. However, the large size of these detectors (typically the entrance cone must be >0.3 in. for good collection efficiency) makes them unsuitable for mounting beneath the column in applications requiring short working distances. Their large size also prohibits using them with miniature electron beam columns in an “in-lens” configuration.

Accordingly, a new apparatus and method are needed to overcome the above-mentioned deficiencies.

### SUMMARY

Embodiments of the invention use solid state devices to overcome the above-mentioned deficiencies. Solid state devices are commonly used as radiation detectors because of their high gain, low background noise, superior energy resolution, and fast response to incident pulses. For example, photodiodes are regularly used for detecting photons and charged particles, both for spectroscopy and for current measurements In SEM's, solid-state detectors are most typically used as backscattered electron detectors with one or more independent channels.

The mounting configuration and signal-to-noise characteristics of an electron detector in an SEM are critical for high-contrast imaging of secondary electrons emitted from the sample. The small working distance in miniature electron beam columns prevents the use of conventional secondary electron detectors. As described further below, solid state detectors configured for detecting backscattered and secondary electrons have significant advantages over conventional secondary electron detectors.

The gain of a solid state detector is linear with incident electron energy over a wide energy range. This characteristic enables secondary electron imaging by operating the detector at a positive potential in order to accelerate secondary electrons into the detector. Solid state detectors can be made extremely thin (0.1-0.5 mm for example), enabling shorter working distances and improved collection efficiency at short working distances. The dead zone around the center aperture can be minimized in solid state detectors, resulting in high collection efficiency in the region where secondary electrons are concentrated. Because solid state detectors can be fabricated in different geometries, they can be integrated with miniature electron beam columns, which facilitates assembly and enables simplified interconnect routing. Solid state detectors can be cleaned following contamination using standard semiconductor cleaning processes. Solid state detectors have the added benefit of being manufactured using standard IC processes, making them easy to integrate with other similarly manufactured and IC complementary components.

Solid state detectors have the additional advantage that they may be operated over a wide range of sample chamber pressures. MCPs and continuous dynode electron multipliers are restricted to operation at pressures <10⁻⁵ torr, and they achieve optimal performance at <10⁻⁶ torr. Because solid state detectors have no thin pores or small high voltage gaps, they can be used over a wide range of pressures, making them well-suited for Variable Pressure Scanning Electron Microscopy (VPSEM), in which sample chamber pressures range from 10⁻³ torr up to >10 torr.

In an embodiment, a charged particle beam (for example, and electron or ion beam) column package includes an assembly (e.g., a plurality of layers, which can have a lens component coupled to one of the layers), and a solid state detector coupled to the assembly. Further, at least one of the layers has interconnects thereon.

In an embodiment, a method comprises: generating a charged particle beam; focusing the beam with the charged particle column; scanning the beam over a target; and detecting secondary electrons with the detector. In an embodiment, the method further comprises detecting backscattered electrons.

Accordingly, embodiments of the invention can, in particular, achieve high-contrast secondary electron imaging while benefiting from the aforementioned advantages inherent in solid state detectors.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an apparatus incorporating an charged particle column having a solid state detector according to an embodiment of the invention;

FIG. 2 is a block diagram illustrating a column of the apparatus of FIG. 1 in cross section integrated with a solid state detector for secondary electrons, mounted to the bottom of the column;

FIG. 3 is a block diagram illustrating a solid state detector with a center aperture;

FIG. 4 is a block diagram illustrating a solid state detector with a split cathode and a center aperture;

FIG. 5 is a block diagram illustrating a solid state detector with a cathode segmented into quadrants and a center aperture;

FIG. 6 is a block diagram illustrating a column of the apparatus of FIG. 1 in cross section with a solid state detector for secondary electrons, integrated with the column;

FIG. 7 is a secondary image acquired using the apparatus of FIG. 1 having a miniature charged particle column using a silicon photodiode detector operated at 1 kV; and

FIG. 8 is a flowchart illustrating a method 800 of using a charged particle column package with an integrated solid state detector for imaging with secondary electrons.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

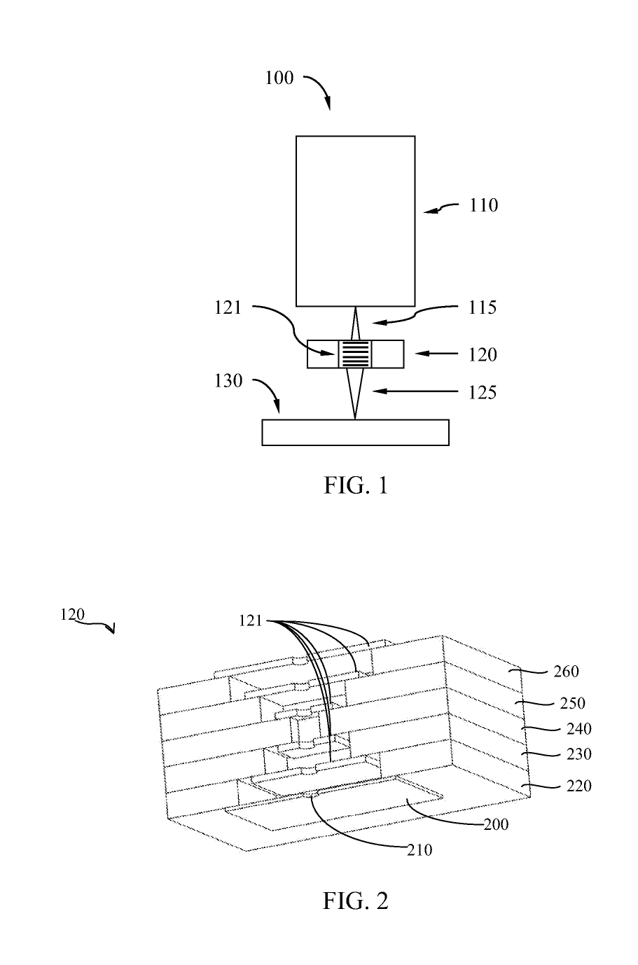

FIG. 1 is a block diagram illustrating an apparatus 100 incorporating, in this embodiment, a charged particle beam column package 120. In embodiments of the invention, the apparatus 100 includes scanning electron microscopes, lithography, inspection, and analysis tools. The apparatus 100 includes an electron source 110 (cathode), such as an thermal field emitter (TFE), positioned adjacent to a beam column package 120, which supports the lenses, deflectors, blankers, magnetic or electrostatic, and other elements required for the column operation (heretofore components 121). The package 120 and components 121 form the package assembly which is positioned adjacent to a sample holder 130. In an embodiment of the invention, the electron source 110 is positioned above the beam column package 120 and the sample holder 130 is positioned below the beam column package 120.

In an embodiment of the invention, the electron source 110 emits electrons 115 by field assisted thermionic emission. The electron source 110 can also comprise a Tungsten or LaB₆ filament, or any of a multitude of cold field emitters, including carbon nanotubes and microfabricated field emission tips. The electrons 115 can have an energy ranging from a few hundred eV to up to about 5 keV. The components 121 coupled to the beam column package 120 extract, collimate, and focus the electrons 115 into an electron beam 125, which is emitted from the package assembly as an electron beam 125. The package assembly scans the focused the beam 125 over the sample holder 130.

In an embodiment in which the apparatus 100 includes a scanning electron microscope, the sample holder 130 holds an object for imaging. The electron beam 125 strikes the object causing the emission of electrons which are detected by a solid state detector 200 (FIG. 2). The detected electrons may include backscattered and secondary electrons. The detected electrons are then used to generate an image of the object. In an embodiment of the invention, a silicon drift detector (SDD) or other photon detector can be used in addition to the solid state device in order to detect photons. The detected photons are then used for materials identification and analysis.

Because the detector 200 and the lenses 121 are manufactured using IC processes and the package 120 is designed for integration with components manufactured using these processes, the detector 200 can be easily integrated with the column. FIG. 2 is a block diagram illustrating the package (also referred to as column) 120 of the apparatus 100 in cross section integrated with the solid-state detector 200 for secondary electrons, mounted to the bottom of the column 120 and in proximity to the objective lens. Lens components 121 are integrated into the same package 120 to form a complete miniature electron beam column with an integrated secondary electron detector. Interconnects for the detector signal may be routed internally through the package 120. The detector 200 can be isolated from the rest of the column through the package 120 so that it can be operated at a floating potential in order to achieve sensitivity to secondary electrons. Because the solid state detectors 200 suitable for this application are fabricated using technologies similar the technologies used to fabricate the lenses and other components 121, the detector 200 can be integrated directly with the lenses so that aperture 210 is simultaneously a lens and detector element.

The beam column package 120 eliminates individually wired interconnects common to conventional scanning electron microscopes and lithography devices and replaces them with high density, batch-processed, printed circuitry. This is achieved using ceramics. For example, low temperature co-fired ceramic (LTCC) using, for example, materials from DuPont (e.g., 951 or 943) or Ferro (e.g., A6-S or A6-M), or high-temperature co-fired ceramic (HTCC) using, for example, materials from Kyocera, polyimide, or any other layering technology that produces a rigid package. The beam column package 120 is built layer-by-layer, up to 30 layers or more, and has interconnects strategically distributed on each layer using high-resolution pattern transfer, thereby yielding up to 60 surfaces or more for patterning and enabling the exposed surfaces to be reserved for termination pads for contact to flexible printed circuit (Flex PC) connectors or other high density interface. In contrast, miniature columns fabricated using alternative technologies have incorporated platforms or packages with significantly fewer surfaces for patterning.

In an embodiment in which some or all of the components 121 are fabricated on a single layer of silicon or other material, layered technology, such as LTCC technology, significantly reduces the complexity and fabrication time as well as increases reliability and yield of the lens elements. Isolating elements are incorporated into the column package 120, thereby eliminating bonded glass spacers or other isolation elements that are individually attached to each lens or component before packaging.

Other advantages of using LTCC or HTCC technology include the ability to batch process and fabricate in high volume; fabrication at very low cost; packages with assembled components can be 100% electrically tested before shipping and are extremely reliable; packages provide a significant increase in real estate available for printed interconnects, ground planes, strip lines, embedded active and passive devices, external active and passive devices, and GHz drivers placed close to the components 121; packages are ultrahigh vacuum compatible; packages are rigid and durable; supporting low-loss high-speed interconnects (>1 GHz) because layered materials, such as LTCC, have low dielectric constants; supporting low-loss high-speed interconnects (>1 GHz) by enabling printing strip-lines and micro-strip-lines; hermetically sealing internal interconnections to prevent reliability failures and provide back to front vacuum isolation; lithographically printing interconnections with good resolution and registration; sufficient real estate for redundancy, scaling, or the addition of electronics or either passive (e.g., resistors, capacitors) or active devices; and standard connectors or connectors mating to Flex PC cables can easily be integrated with the column.

In an embodiment, the beam column package 120 comprises five layers 220-260 (each individually layer possibly comprised of several layers) stacked one on top of another, five components 121, and one detector 200. Each layer can have one or more components coupled to it (one per side). In an embodiment of the invention, the column package 120 can comprise a different number of layers and/or components. A component can include a single device like, for example, a silicon lens element, or a stack of devices like, for example, silicon lenses electrically isolated by an insulator like, for example, Pyrex. The number of devices in a stack not limited.

The top and bottom surface of the layers 220-260 are available for printed circuitry. Each electrical interconnect can be made to terminate at a pad on the top of the layer 260, the bottom of the layer 220, or any combination. Electrical connections between layers are made as needed by vias in the layers 220-260. Connection to external power supplies can be made using, for example, flexible printed circuit (FlexPC) connectors.

Pads can be printed on each layer 220-260 to allow each component 121 to be attached and made electrically connected using either manual techniques or production assembly techniques like, for example, a bump or ball bonding. Each component 121 of the column 120 is aligned and attached directly the column 120. The precise alignment needed can be done using marks printed on each component 121 and layers 220-260. The column 120 can have cutouts to view the marks and registration features when the assembly is completed to perform or verify alignment. Pads printed on the topmost layer 260, bottommost layer 220, or on any other layer whereby a cutout is made to expose a surface can be used for attaching connectors that mate with a FlexPC or other high density interface to the package using either manual techniques or production assembly techniques like, for example, a bump or ball bonding or soldering, the former being simpler, cheaper and more reliable. The advantage of using layered ceramic technologies with standard pick-and-place attach processes and FlexPC attach methods are many. LTCC technology, for example, is a mature technology that allows batch processing, printed interconnects, and 100% electrical and mechanical testing of the components and subassemblies. Assembling a column can be done in high volume production using a variety of techniques. There is no contamination or other reliability problem. Layered processing achieves smooth, flat, and parallel surfaces for component attachment. The layer thickness is very well controlled. Electrical connection to a large number of pads is possible, and active and passive devices can be hermetically sealed inside the package. LTCC, HTCC, and other layered process are compatible with lapping and polishing processes which can be used to create packages with extreme parallelism (TTV), flatness, and smoothness. These technologies allow easy integration with Flex PCs and other external devices.

Each layer 220-260 can be made square shaped (or otherwise shaped) with one or more square, or otherwise, shaped cutouts to enable placement of a component, transmission of electrons, or other function. Components 121 may include discrete elements like lenses, deflectors, blankers, etc., or assemblies of elements such as fabricated lens or deflector stacks. Layers can vary in thickness, for example from 3.7 to 8.2 mils for LTCC and significantly more for HTCC and polyimide processes. Each layer 220-260 can have the same thickness or their thicknesses can vary from each other.

In an embodiment, the column assembly 120 can include mechanical fixturing to attach the solid state detector 200 to the column assembly 120. This facilitates removing the solid state detector 200 for servicing, cleaning, or replacement.

Technology used for building the column 120 is described in further detail in U.S. Pat. No. 7,109,486 issued Sep. 19, 2006 and incorporated herein by reference.

To detect secondary electrons, the detector 200 is operated at a positive potential to accelerate secondary electrons into the solid state device 200. Signal at the output of the detector results from hole-pair formation at the diode junction caused by the incident electron energy. The gain of a solid state device 200 is linear with incident electron energy over a wide energy range. This characteristic means that the scanning electron microscope's image contrast can be improved significantly by increasing the detector's 200 operating voltage. For example, a silicon photodiode with a 4 nm passivation layer has a gain of 200 for 1 kV electrons. The gain increases to 700 for 3 kV electrons.

The solid state device 200 can be operated in reverse bias mode, wherein the cathode is held at a slightly positive potential with respect to the anode. This mode of operation reduces the effective capacitance of the device 200, significantly increasing the detector's response time with little effect on gain and slight deterioration in noise performance. The detector may also be operated in both reverse bias and with a positive total potential.

When the detector 200 is operated at a positive potential, the center aperture 210 may be grounded in order to prevent distortions in the primary electron beam. Similarly, a grounded grid over the detector 200 may prevent field from the detector 200 from affecting the primary beam or the sample.

By adjusting the operating voltage, the solid state detector 200 can be used to acquire images either of backscattered electrons only, or of a mixture of backscattered and secondary electrons. For example, the responsivity of a silicon photodiode with a 4 nm passivation layer drops to zero for electron energies <80 eV. Operating <80 eV, the detector collects backscattered electrons only. Above 80 eV, the detector collects a combination of backscattered and secondary electrons.

Standard semiconductor processes allow significant control over the geometry and thickness of the solid state detector 200. This makes such devices 200 particularly well-suited for integration into the miniature electron beam column 120, where space between lenses is extremely tight. MCP thickness is determined by the length of the channels, which require aspect ratios >40:1 for sufficient gain. The thickness of the solid state detector is limited only by the silicon thickness (typically <0.3 mm), enabling both operation at smaller working distances and improved collection efficiency at a given working distance. In contrast with MCPs, which tend to have large dead areas around their center apertures, solid state detectors can be fabricated with active areas in very close proximity to their center apertures. Secondary electrons are emitted from the sample in a narrow cone around the incident beam, with the highest concentration of secondary electrons emitted near 90 degrees from the plane of the sample. Therefore, the solid state detector's 200 increased active area near the center aperture results in significantly increased collection efficiency.

The solid state detector 200 can be made extremely thin (0.1-0.5 mm), which allows for improved working distance and collection efficiency. For example, a 0.2 mm thick solid state detector 200 mounted beneath the electron beam column's 120 pole piece and operating at 3 kV has the same gain as a single-stage 0.5 mm thick MCP in the same configuration. Because the solid state detector 200 can be fabricated with its active area closer to the center aperture 210, it can achieve better collection efficiency than the MCP. Furthermore, the thinner solid state detector 200 allows for an additional 0.3 mm of working distance that would otherwise be taken up by the MCP's thickness.

During the course of operation, it is possible that contaminants may be ejected from the sample and deposited onto the surface of the solid state detector 200, resulting in a deteriorated signal-to-noise ratio. Following such contamination, the detector 200 surface can be cleaned using mechanical, chemical, or plasma cleaning techniques that are standard for solid state devices and semiconductor processes. Such cleaning processes can fully restore the device's 200 original signal-to-noise characteristics, significantly extending the detector's 200 useful lifetime. The MCP cannot be aggressively cleaned in the same way, so it typically must be replaced in the event of contamination.

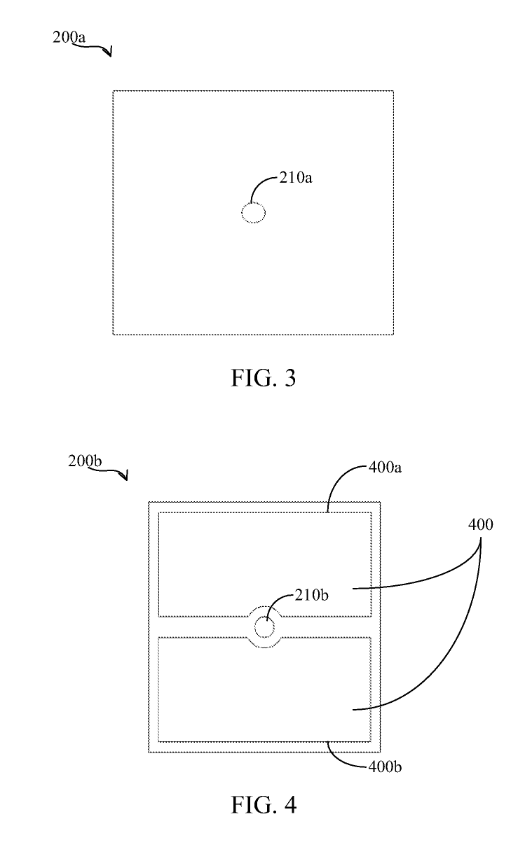

FIG. 3 is a block diagram illustrating a solid state detector 200a with a center aperture 210a. In this embodiment of the invention, the detector 200a includes an aperture 210a that may be held at ground potential to prevent field from the detector 200a from interfering with the primary electron beam. The aperture 210a enables high collection efficiency by allowing a large detector active area within close proximity to the primary electron beam, where secondary electrons are concentrated. In an embodiment, the detector 200a does not have an aperture 210a.

FIG. 4 is a block diagram illustrating a solid state detector 200b with a split cathode 400 and a center aperture 210b. In this embodiment of the invention, the solid state secondary electron detector 200b is split into two sections 400a and 400b, with each section isolated from each other in order to detect current separately. The signals from detector area 400a and detector area 400b may be recorded separately in order to analyze electrons that are ejected at preferential angles from the sample, or the signals may be tied together to collect the total current and thereby increase the overall signal-to-noise.

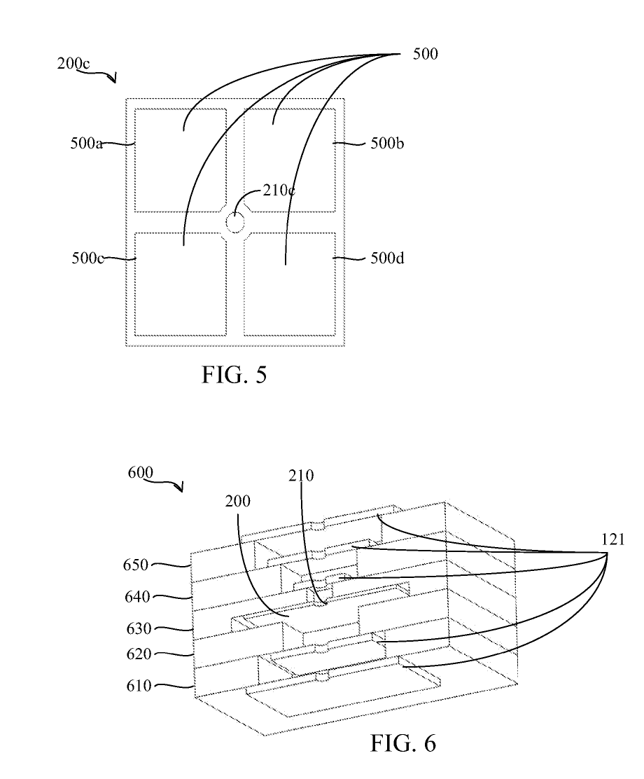

FIG. 5 is a block diagram illustrating a solid state detector 200c with a cathode 500 segmented into quadrants 500a-500d and a center aperture 210c. Each quadrant 500a-500d is isolated. The signals from detector areas 500a-500d may be recorded separately or they may be tied together. It is clear that the detector 200c can be segmented into any number of segments, or operated as a single segment, with each having any shape required to meet the specific needs of any particular application.

FIG. 6 is a block diagram illustrating a column 600 in cross section with the solid-state detector 200 for secondary electrons, integrated with the column 600 in another embodiment. The column 600 is substantially similar to the column 120 with a plurality of layers 610-650. The solid state electron detector 200 is mounted onto the column 600 between lens components 121. This embodiment of the invention allows the detector 200 to be mounted at some distance from the sample. Mounting the detector 200 further up the column 120 in this way enables high collection efficiency for backscattered electrons, which are emitted from the sample in a narrow cone around the primary electron beam. It also moves the detector 200 above the final lens where is does not affect the working distance. This method can also increase collection efficiency for secondary electrons that drift up the column.

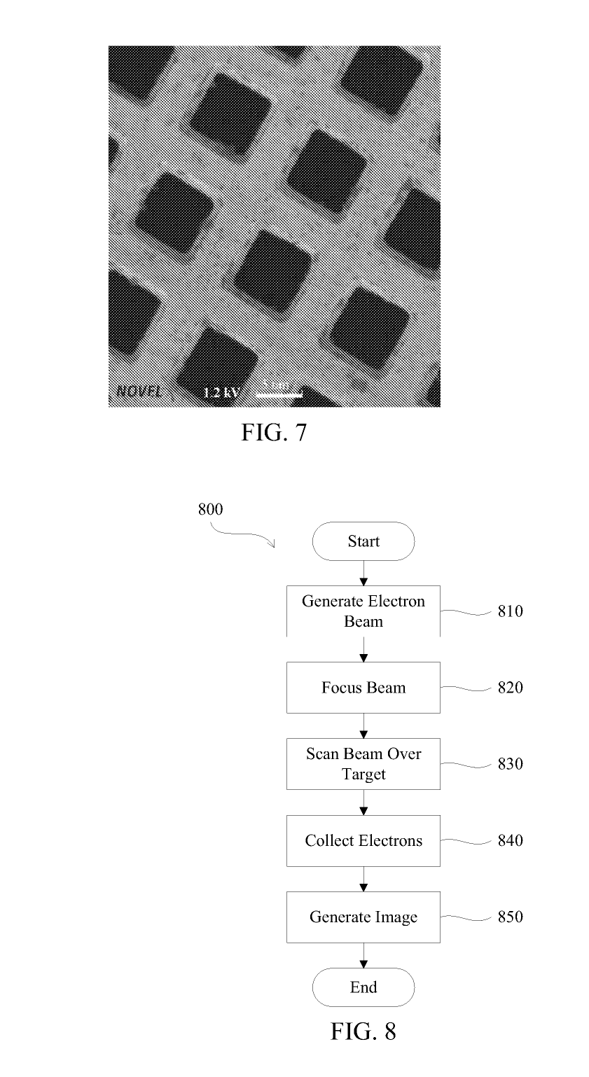

FIG. 7 is a secondary image acquired using the apparatus of FIG. 1 having a miniature electron beam column, such as column 120 or 600, using a silicon photodiode detector, such as the detector 200, operated at 1 kV. This image of a copper grid demonstrates the effectiveness of using a solid state electron detector to acquire high-contrast secondary electron images in an SEM.

FIG. 8 is a flowchart illustrating a method 800 of using an electron beam column package 120 for imaging with secondary electrons. First an electron beam is generated (810). The beam is then is focused (820) using focusing components coupled to beam column package 120. The beam is then scanned (830) over a target using silicon components in the column package 120. The scanned beam impacts the target, generating backscattered and secondary electrons (and/or x-rays), which are collected (840) by the solid state detector 200. An imaging device then generates (850) an image based on the collected electrons. The method 800 then ends.

The foregoing description of the illustrated embodiments of the present invention is by way of example only, and other variations and modifications of the above-described embodiments and methods are possible in light of the foregoing teaching. For example, the column 120 and 600 can be used for ions, not just electrons. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A charged particle beam column package, comprising:
an assembly; and
a solid state secondary electron detector coupled to the assembly.

2. The beam column package of claim 1, wherein the assembly includes a plurality of layers and wherein the plurality of layers is made from ceramic.

3. The beam column package of claim 2, wherein the plurality of layers is made from LTCC or HTCC.

4. The beam column package of claim 1, wherein the solid state detector is coupled to a bottom of the assembly.

5. The beam column package of claim 1, wherein the solid state detector is coupled to a middle of the assembly.

6. The beam column package of claim 1, wherein the solid state detector includes a silicon photodiode detector.

7. The beam column package of claim 1, wherein the solid state detector operates with a positive potential in a reverse bias mode.

8. The beam column package of claim 1, wherein the detector operates with a positive potential in an unbiased mode.

9. The beam column package of claim 1, wherein the detector includes an aperture that is grounded when the detector is operated at a positive potential.

10. The beam column package of claim 1, further comprising a grounded grid over the detector.

11. The beam column package of claim 1, wherein the detector is integrated with a lens or set of lenses.

12. A scanning charged particle microscope incorporating the beam column package of claim 1.

13. A method, comprising:
generating a charged particle beam;
focusing the beam with a charged particle beam column, the beam column package having an assembly, and a solid state detector coupled to the assembly;
scanning the beam over a target; and
detecting secondary electrons with the detector.

14. The method of claim 13, wherein the assembly comprises a plurality of layers and wherein the plurality of layers is made from ceramic.

15. The method of claim 14, wherein the plurality of layers is made from LTCC or HTCC.

16. The method of claim 13, wherein the solid state detector is coupled to a bottom of the assembly.

17. The method of claim 13, wherein the solid state detector is coupled to a middle of the assembly.

18. The method of claim 13, wherein the solid state detector includes a silicon photodiode detector.

19. The method of claim 13, further comprising operating the solid state detector with a positive potential in a reverse bias mode.

20. The method of claim 13, further comprising operating the solid state detector with a positive potential in an unbiased mode.

21. The method of claim 13, wherein the detector includes an aperture that is grounded when the detector is operated at a positive potential.

22. The method of claim 13, further comprising a grounded grid over the detector.

23. The method of claim 13, wherein the detector is integrated with a lens or set of lenses.
